(19) United States
(12) Patent Application Publication
(10) Pub. No.: US 2009/0047826 A1
(43) Pub. Date: Feb. 19, 2009

(54) PORTABLE SURGE PROTECTED POWER DISTRIBUTION SYSTEM

(76) Inventor: James Velco, Chicago, IL (US)

Correspondence Address: SACHNOFF & WEAVER, LTD., 10 SOUTH WACKER DRIVE, CHICAGO, IL, 60606-7507, US

(21) Appl. No.: 11/840,727

(22) Filed: Aug. 17, 2007

(51) Int. Cl. H01R 13/72

(52) U.S. Cl. 439/501

(57) ABSTRACT

A portable surge protected remote power distribution system for delivering electrical power to an area of a venue comprises a moveable cart assembly and a surge protector mounted on the cart assembly. The surge protector has a first electrical cord adapted to be electrically connected to a source of electrical energy at the venue. At least one retractable houses a second electrical cord, and the reel is mounted on the cart assembly. Each second cord has a predetermined length, and one end of each second cord is adapted to extend to a point in the venue at a predetermined distance from said cart assembly substantially equal to the predetermined length of each second cord. A second end of each second cord is electrically connected to the surge protector. At least one power strip is removably mounted on the cart assembly, and one end of each second cord of the self retractable reel is electrically connected to a power strip, each power strip having a socket adapted to electrically connect with an electrically powered device.

The present invention relates to systems and devices for remotely distributing power for use by electrical and electronic technology devices, and in particular to a system and device for remotely distributing surge protected electric power in venues that have limited or no remote AC power outlets to power sensitive electrical and electronic devices.

### BACKGROUND OF THE INVENTION

The use of electrical powered portable devices has increased exponentially over the past several years, enabling users to deploy electrically powered devices such as laptop computers, PDA's, computer based scientific detection and analysis instrumentation, communications devices, and others, at remote locations. Many of these devices include battery power supplies, rechargeable or not, that provide electrical power to operate such devices for only a limited time, depending on the construct and capacity of the battery. If rechargeable, the battery unit must be connected to a source of AC current to complete the recharging process.

Several venues where the use of portable electrical and electronic technology devices has expanded include classrooms, lecture and event halls, outdoor venues, live music events, just to name a few. Many of these venues were not wired, when initially constructed, to sufficiently handle the needs of laptop computer users, mobile phone users, and users of other sensitive electronic equipment. The operating system of portable electronic devices used at such venues can be wirelessly connected to an internet-based, or other, source of information communication, but such wireless connection is possible only during the time the batteries in the electronic technology device remain sufficiently charged to deliver the required amount of electric operating power to the unit. By way of example, a lecture hall at a school, college or university, constructed as early as 15-20 years ago, would not have been designed in contemplation that one hundred or more students at one time may be sitting in the hall taking lecture notes, or taking an exam, using an electrically powered laptop computer instead of pen and paper. This scene occurs daily in our schools throughout the world, and in other venues as well.

One solution to this problem is to re-wire the electrical power outlet system in each room of a given multi-inhabitant venue to increase the amount of available AC electric outlets. As is readily understood, this would be an expensive re-construction project, possibly leading to undesirable increased education costs.

Devices shown in the prior art do not teach or suggest a portable device that can deliver surge protected electrical power over a wide area and many feet away from an existing AC power outlet. For example, U.S. Pat. No. 6,702,608 describes a relatively portable electric workstation with power cord reels for powering electrical tools and equipment, with single-plug extension cords wound around reels located in the workstation cabinet. The apparatus shown in U.S. Pat. No. 6,702,608 does not provide surge protection to a multiplicity of outlets to which sensitive technological devices are to be electronically connected. In addition, this prior art patent does not disclose power strips to provide multiple outlets from the cord reels.

U.S. Pat. No. 6,170,839 discloses a wheeled cabinet-type tool cart on a hand truck structure that includes at least one electrical extension cord reel 16 connected to a multiple socket outlet 34 that is directly mounted to the tool cart cabinet. A second extension cord reel 18 is electrically connected to the electrical cord of the first extension cord reel 16. The opposite end of the second extension cord reel, as distinguished from the opposite end of the extension cord itself, is connected to a female outlet 19. The device of this patent is not constructed to provide surge protection for sensitive technological devices, nor does the disclosed device provide power strips with multiple outlets extending directly from electrical wires wound on the cord reels.

Therefore, an object of the present invention is to provide a portable, lightweight, easily moveable AC electrical power distribution system that can distribute electrical power through multiple sockets over a wide area of a venue from a single extant power outlet in or adjacent the venue. Since the expected users of the subject power distribution system will be operating sensitive electrical technology components electrically connected to the available sockets, a surge protection device is assembled in line with each remote socket, for the purpose of protecting the user's technology equipment when the power distribution system of the present invention is utilized. In buildings that were not constructed with the need for powering today's advanced electrical and electronic technology devices, the present invention is an inexpensive solution to providing protected electrical power where needed in a given venue, without the time and cost of installing new circuits, conduits and outlets in existing infrastructure.

Another object of embodiments of the present invention is to provide electrical cords on self-winding reels, where the cords themselves are either hardwired or releasably connected to the electrical input of the reel structure, and where multiple-socket power strips can be either hard wired or releasably connected to the cords wound around the reels.

A further object of the present invention is to provide at least one multiple-socket power strip electrically connected to a self-reeling electrical cord at one end of the cord, and to a source of electrical power at the other end of the cord, with a power surge arrester or protector connected in electrical alignment between the source of electrical power and the self-reeling cord.

In one embodiment, the surge protector forms part of the housing for the self-reeling cord.

In a further embodiment, foldable solar panels and solar-chargeable batteries provide the electrical energy input for the portable electrical distribution system of the present invention.

In another embodiment, a storage tray is provided with the portable electrical distribution system.

### SUMMARY OF THE INVENTION

To accomplish these and other objectives, the present invention provides a portable surge protected remote power distribution system for delivering electrical power to an area of a venue, including a moveable cart assembly and a surge protector mounted on the cart assembly. The surge protector includes a first electrical cord adapted to be either electrically connected to a source of electrical energy at a venue, or to be electrically connected to a retractable reel, housing an electrical cord which is then electrically connected to a source of electrical energy at a venue. At least one retractable reel, housing a second electrical cord, is mounted on the cart assembly, the second cord having a predetermined length. One end of each second cord is adapted to extend to a point in the venue at a predetermined distance from the cart assembly substantially equal to the predetermined length of each second cord. A second end of each second cord is electrically connected to the surge protector. At least one power strip is removably mounted on the cart assembly, and one end of each second cord is electrically connected to a power strip. Each power strip has at least one socket adapted to electrically connect with an electrically powered device.

### BRIEF DESCRIPTION OF THE DRAWINGS

FIG. 1 is a front perspective view of an embodiment of the portable remote surge protected power distribution system of the present invention, showing a pair of power strips removably mounted on the moveable cart assembly, showing the power cords for the power strips in their reeled position, and showing the handle for the cart assembly in its fully extended position;

FIG. 2 is a rear perspective view of the embodiment of the present invention illustrated in FIG. 1;

FIG. 3 is a front-top perspective view of the embodiment of the invention shown in FIGS. 1 and 2, showing the cart assembly handle in the fully retracted position;

FIG. 4 is a rear-top perspective view of the embodiment of the invention shown in FIGS. 1 and 2, showing the cart assembly handle in the fully retracted position, and showing the surge protector mounted on the cart assembly;

FIG. 5 is a rear perspective view of the second embodiment of the portable remote surge protected power distribution system of the present invention of FIGS. 5-8, showing a horizontally mounted surge protector unit and a storage tray mounted on the cart assembly adjacent the surge protector unit;

FIG. 6 is a front-side perspective view of the embodiment of the power distribution system shown in FIG. 5;

FIG. 7 is a view of one of the power strips removed from the cart assembly of the second embodiment and deployed at a remote location in a venue to deliver surge protected electrical power to the remote location;

FIG. 8 is a detail view of the upper and lower mounting brackets on the cart assembly of the present invention, for removably attaching the power strips to the cart assembly;

FIG. 9 is a detail view of an attachment plate mounted on a power strip, the attachment plate removably connecting each power strip to the cart assembly of both embodiments of the present invention; and

FIG. 10 is a detail schematic cross-section view of a modified combined cord reel and surge protector structure used in a further embodiment of the present invention.

### DETAILED DESCRIPTION OF THE ILLUSTRATED EMBODIMENTS

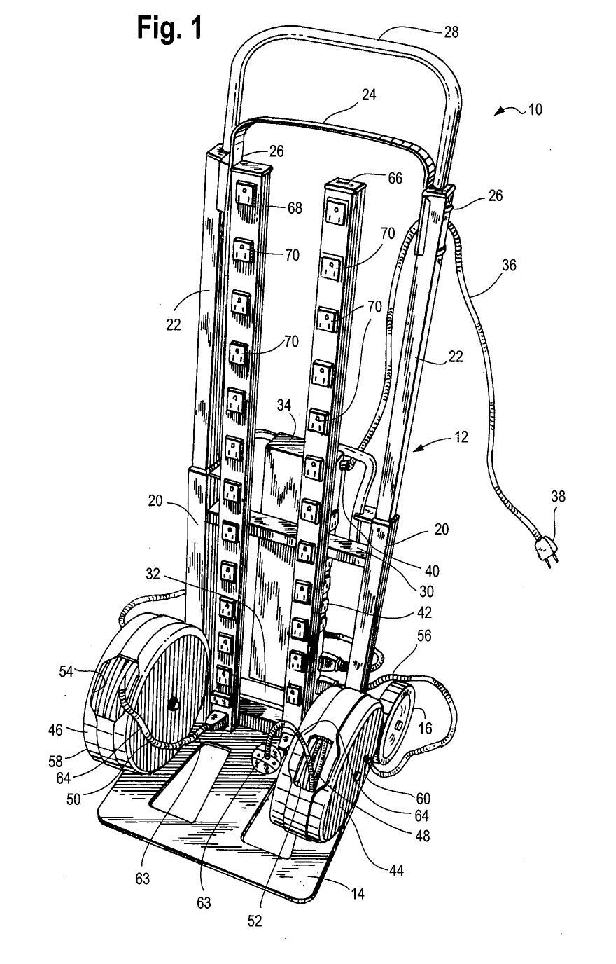

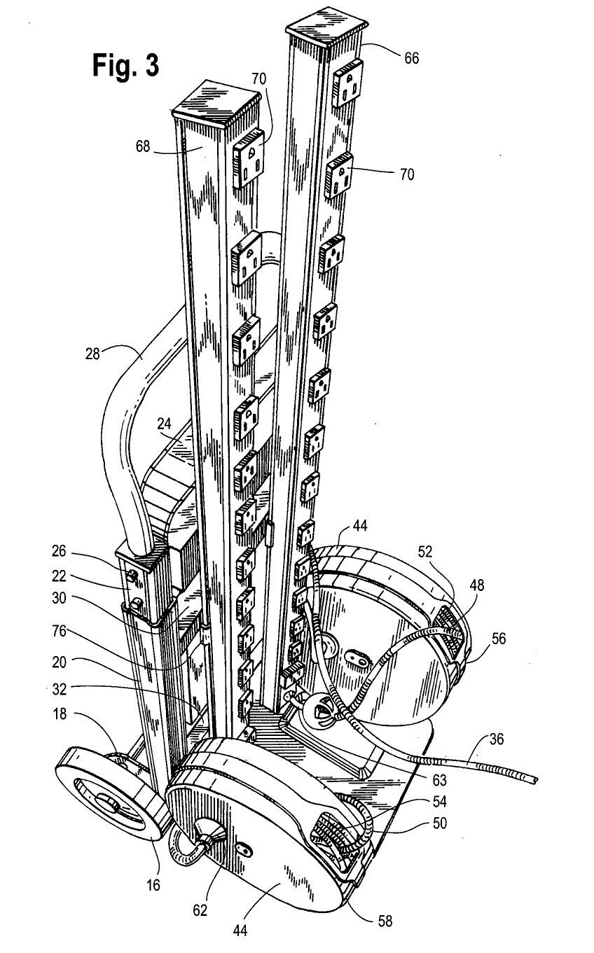

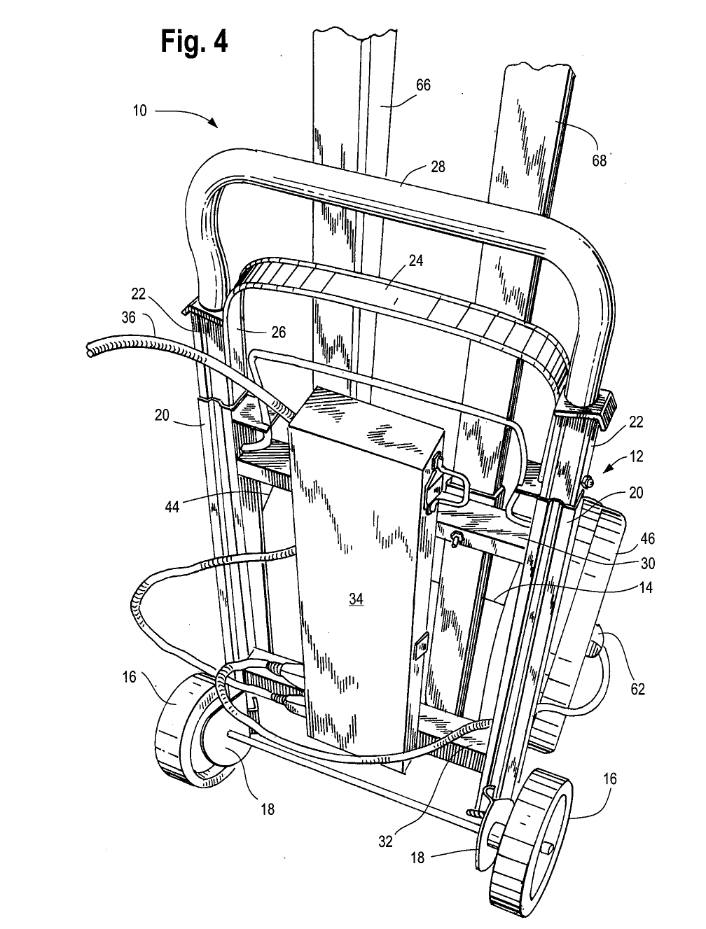

The portable surge protected remote power distribution system of the embodiment of the present invention shown in FIGS. 1-4 is generally designated by the numeral 10. The power distribution system 10 is generally mounted on a moveable cart assembly 12 comprising a platform 14 to which a pair of wheels 16 are rotatably mounted by way of brackets 18. In the illustrated embodiment of FIGS. 1-4, a first pair of hollow tubular shafts 20 are attached to and extend upward from platform 14, and a second pair of tubular shafts 22 are slideably mounted inside the hollow portions of shafts 20. A first brace 24 extends between the upper extents of tubular shafts 22, and the brace 24 is suitably attached to both tubular shafts 22, such as by bolts and nuts 26. A handle 28 is also securely attached between the upper portions of tubular shafts 22 to form a grip when it is desired to move cart assembly 12 from place to place.

An intermediate cross-member 30 extends between and is secured to each of the first pair of tubular shafts 20, providing additional rigidity to the cart assembly 12. Additionally, a lower cross-member 32 extends between and is secured adjacent the lower ends of each of the first pair of the tubular shafts 20. First brace 24, intermediate cross-member 30, lower cross-member 32 and platform 14 combine to provide rigidity and integral strength to the cart assembly 12, allowing additional components to be supported by the cart assembly 12, as will be explained, while allowing the cart assembly to be readily moved from place to place.

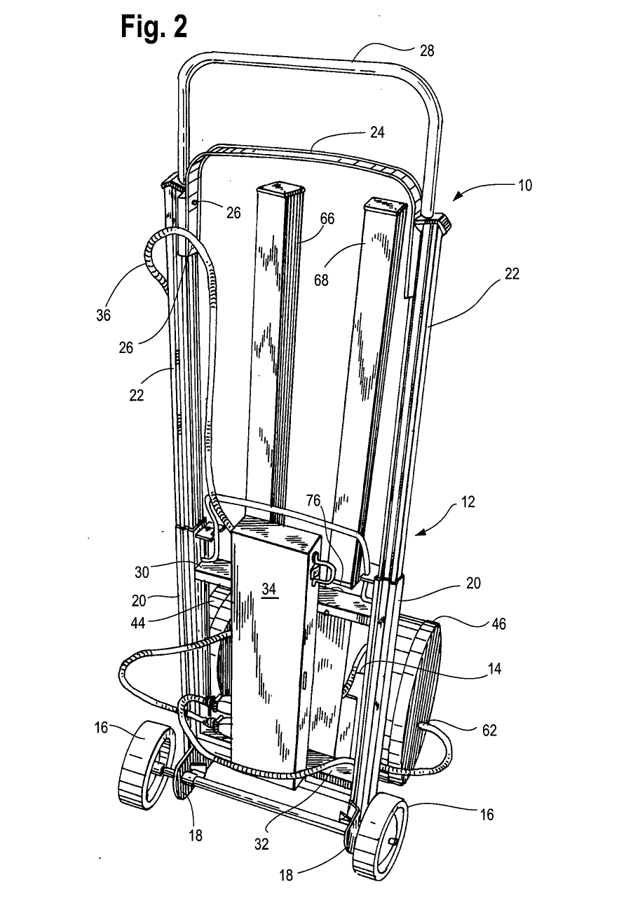

As best seen in FIG. 2, the embodiment of FIGS. 1-4 includes a surge protector device 34 mounted to cross-members 30 and 32. In the illustrated embodiment, surge protector 34 is fixedly secured to cross-members 30 and 32, however it is contemplated that the surge protector 34 may be attached in a way to enable removal and replacement of the surge protector were a defect to occur in the surge protector. The surge protector 34 may be of the multiple socket type manufactured by Tripp Lite, Model DRS-1215, or any equivalent surge protector device qualified to protect sensitive electronic equipment from unwarranted surges in electrical power, should they occur. In the illustrated embodiment, surge protector 34 has a power input cord 36 adapted to have one end 38 be plugged into a source of 110-120 volt AC electrical power, and another end 40 hardwired or removably electrically attached to surge protector 34.

As stated above, it is preferable that surge protector 34 include a plurality of outlet sockets 42 that accept standard AC male electrical plugs or connectors, since the illustrated embodiment includes two cord reel and power strip assemblies that are connected to the surge protector 34, as will be explained. However, the present invention contemplates a construction comprising a single cord reel and power strip assembly electrically connected to surge protector device 34, wherein the surge protector includes a single electrical outlet socket. As stated previously, a purpose of the present invention is to provide a plurality of surge protected electrical sources throughout the area of a given venue. While it is contemplated that the power strips will provide such sources of electrical power, as will be explained, the present invention also provides additional sources of electrical power directly from the electrical sockets 42 built into surge protector 34.

In the embodiment of FIGS. 1-4, a pair of self-retracting electrical cord reels 44, 46 are mounted on platform 14 with the cords 48, 50 adapted to be reeled outward through respective apertures 52, 54 in the casings 56, 58 housing the cord reels 44, 46. If practical, the reels 44, 46 could also be mounted on tubular shafts 20 of cart assembly 12. The cord reels 44, 46 in the illustrated embodiment are of the type manufactured by Coleman Cable, Model 04633, or any equivalent self-retracting electrical cord reel. In the illustrated embodiment of the invention, it is contemplated that each cord reel 44, 46 includes thirty feet of cord 48, 50 that can be extended outward from reel casings 56, 58. However, it is contemplated within the framework of the present invention that the length of cords 48, 50 be suitable to fit with the reels 44, 46, and to adequately cover the area of the venue to which electrical power is to be supplied.

Each of the reel casings 56, 58 include an aperture 60, 62 through which one end of respective cords 48, 50 extend. This end of each cord 48, 50 is electrically connected to output sockets 42 of surge protector 34, as seen in FIG. 2. The present invention contemplates that the connection between cords 48, 50 and surge protector 34 is either by hard wired connections, or by removable plug and socket connections.

The opposite end 63 of each cord 48 and 50, as stated previously, extends out of apertures 52, 54 of reel casings 56, 58, and each cord 48, 50 includes a stop member 64 attached to end 63 to prevent the end 63 of the cords from being reeled to an inaccessible position inside of respective reel casing 56, 58.

In the illustrated embodiment, the opposite end 63 of each cord 48, 50 is electrically connected to a power strip 66, 68, through either a hard wired connection or a removable socket and plug connection. Each power strip 66, 68 includes a plurality of electrical sockets 70 adapted to receive two or three prong electrical connectors (not shown). In the illustrated embodiment, each of the power strips 66, 68 includes twelve electrical sockets 70, but any number of sockets 70 that are practical may be utilized in each power strip 66, 68.

In the illustrated embodiment, the power strips 66, 68 may be of the type manufactured by Tripp Lite, Model PS 3612, or any equivalent power strip that can provide a plurality of electrical outlets to a location remote from the cart assembly 14 in a given venue. In addition, the power strips 66, 68, instead of including a plurality of discrete sockets 70, may comprise multiple parallel channels extending along the length of one side of the power strip, with electrical contacts comprising strips of conductive material disposed beneath the parallel channels. The strips of conductive material, in this embodiment, are the electrical equivalent of the discrete sockets 70, and the strips of conductive metal are electrically connected to cord 48, 50, respectively.

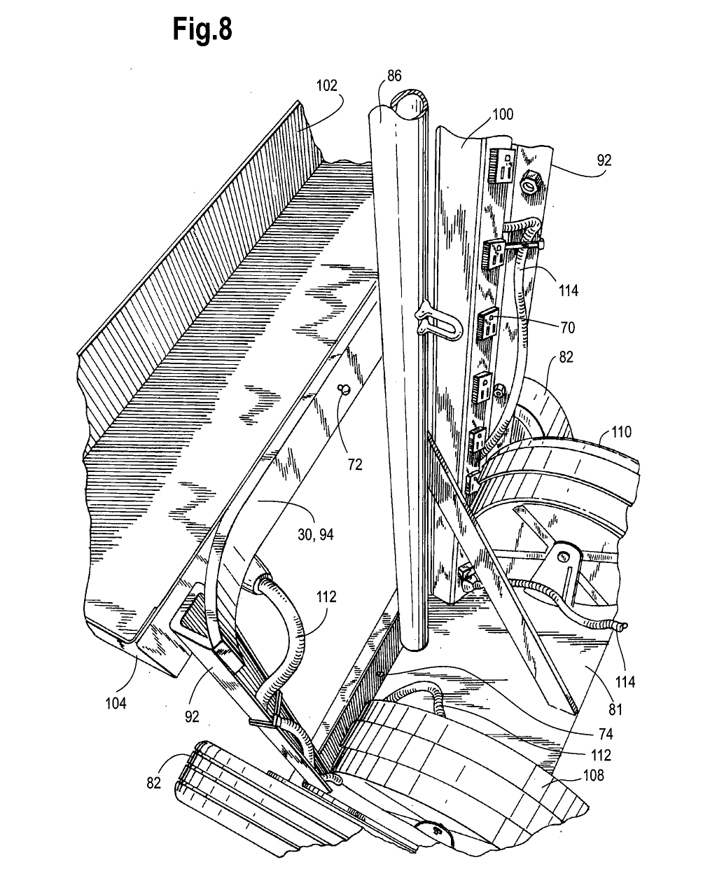

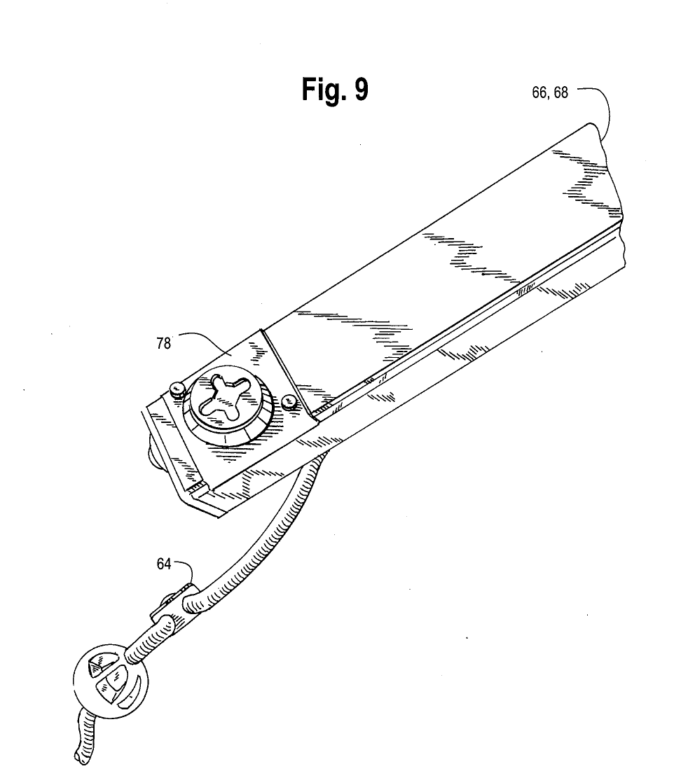

FIG. 8 illustrates a second embodiment of the present invention, however the means for removeably mounting power strips 66, 68 to cart assembly 14 in the first and second embodiments is the same. Referring to FIGS. 8 and 2, intermediate cross member 30 and lower cross member 32 each include a pair of upper and lower, side-by-side mounting supports 72, 74. Correspondingly, each power strip 66, 68 on one side includes a pair of mounting brackets 76 (FIG. 2) and 78 (FIG. 9). To removably mount power strips 66, 68 to cart assembly 14, in all embodiments of the present invention, mounting brackets 76 are extended over mounting supports 72 until the respective power strip is supported by the cart assembly 14. Simultaneously, mounting brackets 78 are extended over mounting supports 74 until the respective power strip is supported by both a mounting support 72 and a mounting support 74. As will be explained, each power strip can be readily removed from cart assembly 14 when adapted for use.

In use, the embodiment of FIGS. 1-4 is moved via handle 28 and wheels 16 to a location near an electrical power outlet in a venue to be supplied with remote electrical outlets, such as a classroom, lecture hall, test venue, outdoor event venue, or the like. Cord 36 is electrically connected to a source of AC current, such as an electrical outlet located in the venue, or an AC electrical generator. In this manner, surge protector 34 is provided with electrical energy through cord 36. At this juncture, the operator ensures that cords 48, 50 are connected between reels 46, 48 and the surge protector 34 so that electrical energy is transmitted through the surge protector to the electrical cords 48, 50.

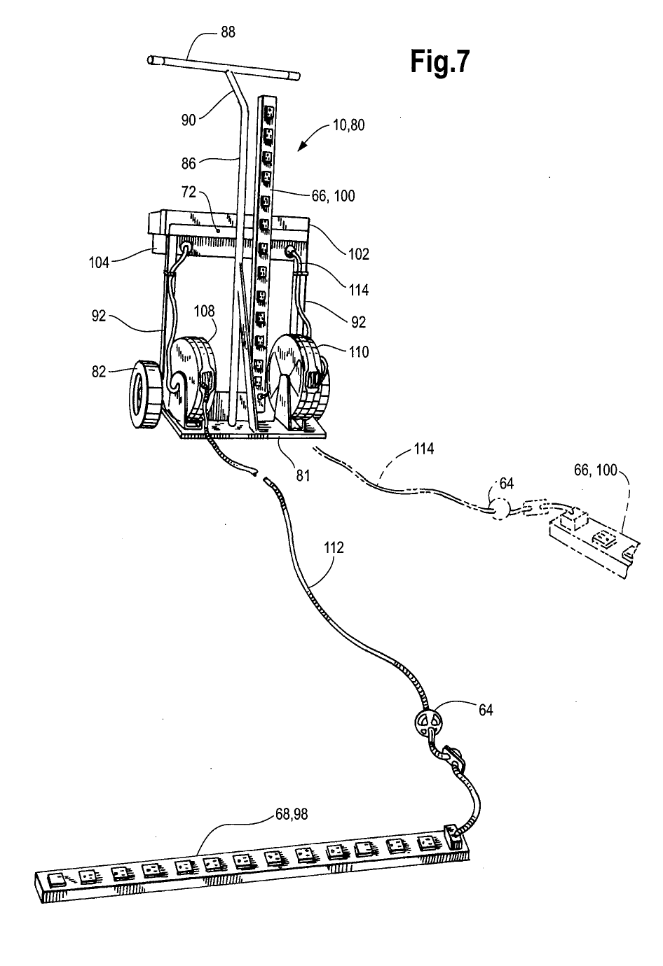

Next, one or both of power strips 66, 68 are removed from their mountings 72, 74 on cart assembly 14, and each power strip 66, 68 is extended away from cart assembly 14 as cords 48, 50 are unreeled from cord reels 44, 46, as shown in the embodiment of FIG. 7. The cords 48, 50 are placed on the floor of the venue, and for additional safety, may be secured to the floor using gaffers tape, or other suitable means, to prevent individuals from tripping over the cords. This places the power strips 66, 68 in a desired location anywhere in a circular area having a radius of about thirty feet in the venue. The ultimate users of the remote surge protected power supply system 10 then can safely connect the power cords of their sensitive electronic or electrical equipment into the sockets 70 on power strips 66, 68 and operate their equipment with confidence. In one example venue, the power system 10 is deployed, as shown in FIG. 7, in a classroom or lecture hall where a quantity of students are taking lecture notes, or taking an examination, utilizing laptop computers or other similar electronic devices.

When the power supply system 10 is no longer needed, the cords 48, 50 are reeled back in casings 56, 58, and power strips 66, 68 are mounted back on mounting supports 72, 74 as previously described. The cart assembly 14 can then be moved to a storage location, or to another location in the venue for additional use.

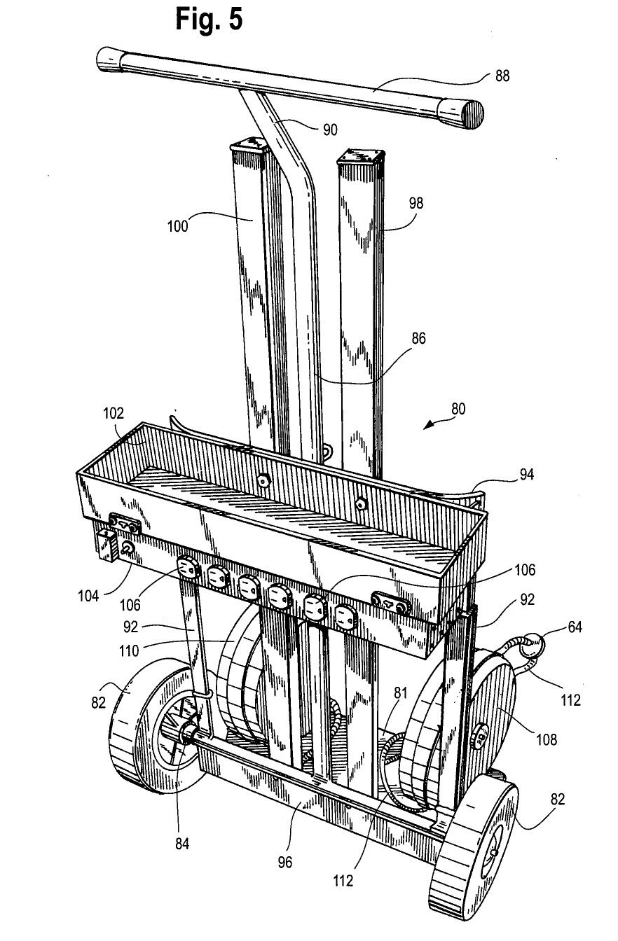

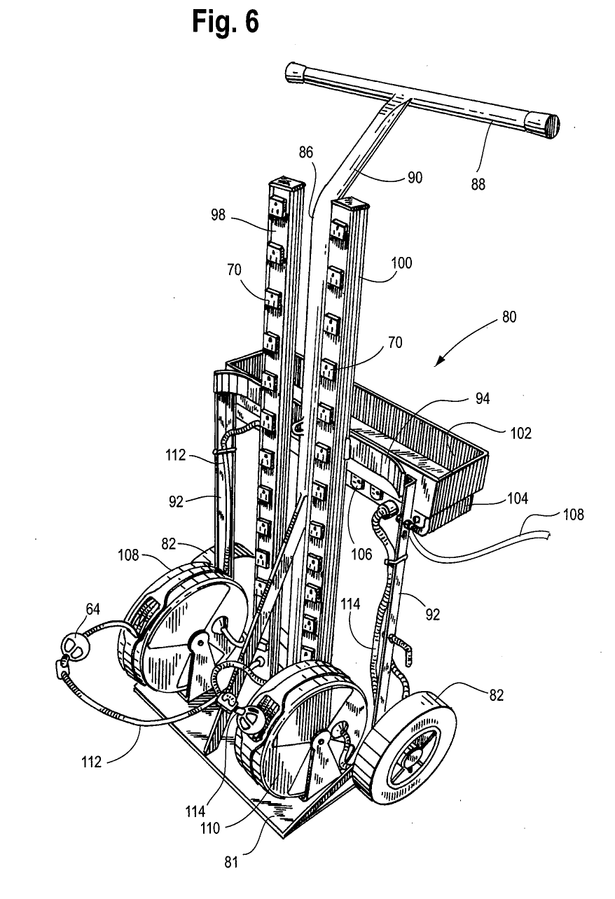

A second embodiment of the present invention is shown in FIGS. 5 through 8. In this embodiment, a cart assembly 80 comprises a platform 81 and a pair of wheels 82 pivotally mounted on an axle 84. The axle 84 is attached to the rear of the platform 81. A single tubular shaft 86 extends upward from platform 81, with a handle 88 mounted at right angle to a bent portion 90 of shaft 86. A brace 92 extends between the mid portion of shaft 86 and platform 81 to securely mount shaft 86 to platform 81.

A pair of upwardly extending angle brackets 92 are attached to platform 81, and an upper cross-member 94 is securely fastened to the upper portion of angle brackets 92. As seen in FIG. 5, a lower cross-member 96 extends between and is fastened to angle brackets 92. Upper cross-member 94 and lower cross-member 96 each include a pair of mounting supports 72, 74 (FIG. 8) upon which power strips 98, 100 are mounted utilizing mounting brackets 78 (FIG. 9), in similar fashion to the removable support for power strips 66, 68 described in association with the embodiment of FIGS. 1-4.

Also attached to upper cross-member 94 in the embodiment of FIGS. 5-8 is a storage tray 102 to hold adapters, extension cords, or other equipment that may be desired for operating the electrical power distribution system of the present invention. The storage tray may include a hinged lid, if desired (not shown).

In the illustrated embodiment of FIGS. 5-8, the surge protector 104 is mounted in a horizontal position on angle brackets 92 just beneath storage tray 102, with the output sockets 106 facing outward to provide easy access to the sockets 106. An electrical cord 108 is electrically connected to surge protector 104, with a plug (not shown) at one end adapted to be connected to a source of AC electrical power.

A pair of electrical cord reels 108, 110, similar to those used in the embodiment of FIGS. 1-4, are also mounted to platform 81, with cords 112, 114 self-retractably mounted in the casing of cord reels 108, 110. One end of each cord 112, 114 is electrically connected to one of the sockets 106 of surge protector 104, while the other end of each cord 112, 114 is electrically connected to the input of a power strips 98, 100, respectively.

As in the previously discussed embodiment, the electrical connections between the components of the power distribution system of the embodiment of FIGS. 5-8 can be either hardwired or removably connected by means of plug and socket devices. Also, the operation of the power distribution system of FIGS. 5-8 is the same as that described in connection with the operation of the embodiment of FIGS. 1-4.

In the embodiment of FIGS. 5-8, the cart assembly 80 is heavier in weight than the embodiment of FIGS. 1-4, and uses a smaller handle to steer the cart assembly. The surge protector 104 is horizontally mounted, and substantially all of the sockets 106 in the surge protector are available as supplemental outlets in the locale of the cart assembly 80.

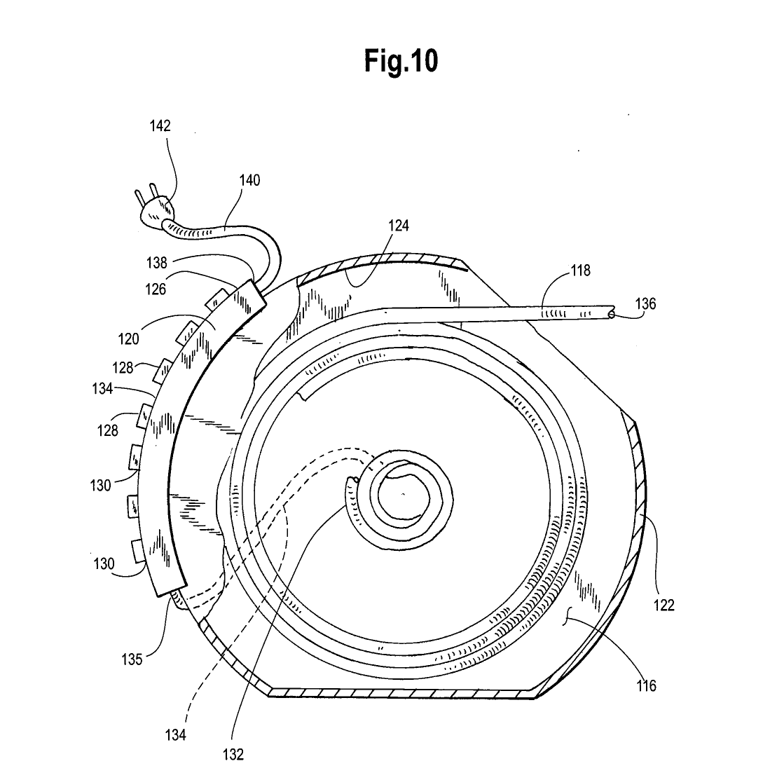

In yet another embodiment of the present invention, as illustrated in FIG. 10, a cord reel 116 housing cord 118 similar to the cord reel and cord assembly disclosed in the previous embodiments is provided, however in this embodiment surge protector 120 is disposed internally of the reel casing 122. In the disclosed embodiment of FIG. 10, surge protector 120 is arcuate in configuration, having the same arc as the interior surface 124 of reel casing 122. In the illustrated embodiment, surge protector 120 is attached to or molded integral with interior surface 124, as is known in the art. The outer surface 126, of the surge protector 120, in this embodiment, includes a plurality of electrical sockets 128, and the surge protector 120 protrudes through an aperture or slot 130 in reel casing 122.

The inner end 132 of cord 118 is attached by cord 134 to an output side 135 of surge protector 120. As in the previous embodiments, the outer end 136 of cord 118 is electrically connected to a power strip, such as designated 66, 68 in the embodiment of FIGS. 1-4. The input end 138 of surge protector 120 is electrically connected to a cord 140 having a plug 142 for attachment of the surge protector 120 to a convenient source of AC electric power.

In operation, the embodiment of FIG. 10 performs in the same manner as the embodiments of FIGS. 1-4 and FIGS. 5-8.

1. A portable surge protected remote power distribution system for delivering electrical power to an area of a venue, comprising:
a moveable cart assembly;
a surge protector mounted on the cart assembly the surge protector including a first electrical cord adapted to be electrically connected to a source of electrical energy at the venue;
at least one retractable reel of a second electrical cord, said reel mounted on the cart assembly, each said second cord having a predetermined length; one end of each second cord adapted to extend to a point in the venue at a predetermined, distance from said cart assembly substantially equal to said predetermined length of each second cord;
a second end of each second cord electrically connected to said surge protector;
at least one power strip removably mounted on the cart assembly, said one end of each second cord of said self retractable reel electrically connected to at least one power strip, each power strip having at least one socket adapted to electrically connect with at least one electrically powered device.

2. The portable surge protected remote power distribution system of claim 1, wherein said cart assembly includes a platform, and said at least one self-retractable reel is mounted on said platform.

3. The portable surge protected remote power distribution system of claim 1, wherein the surge protect includes a plurality of electrically outlet sockets; and the second end of each said second cord is electrically connected to one of said electrical outlet sockets of said surge protector.

4. The portable surge protected remote power distribution system of claim 1, wherein said electrical connection between said at least one second cord and said surge protector, and said electrical connection between said at least one second cord and said at least one power strip is one of a hardwired connection and a removable plug and receptacle connection.

5. The portable surge protected remote power distribution system of claim 1, wherein the cart assembly is mounted on a set of wheels.

6. The portable surge protected remote power distribution system of claim 5, wherein the cart assembly includes a handle attached to the cart assembly.

7. The portable surge protected remote power distribution system of claim 1 wherein said surge protector is located in a casing of said at least one self-retractable reel.

8. The portable surge protected remote power distribution system of claim 7, wherein the casing of said at least one self-retractable reel has an arcuate inner surface portion, and said surge protector is configured in the same arcuate configuration as said inner surface portion.

9. The portable surge protected remote power distribution system of claim 8, wherein said surge protector is one of attached to and formed integral with said inner surface portion.

10. A portable surge protected remote power distribution system for delivering electrical power to an area of a venue, comprising:
a moveable cart assembly;
at least one retractable reel including an electrical cord of a predetermined length, said electrical cord adapted to be selectively extended from said reel a distance substantially equal to said predetermined length, said reel mounted on said cart assembly:
said electrical cord having a first end and a second end;
said first end of said electrical cord being electrically connected to a surge protector, said surge protector adapted to be electrically connected to a source of electrical power;
said second end of said electrical cord being electrically connected to a power strip, said power strip including at least one socket structure, said socket structure adapted to electrically connect with at least one electrically powered device.

11. The portable surge protected remote power distribution system of claim 10, wherein said surge protector is mounted on said moveable cart assembly.

12. The portable surge protected remote power distribution system of claim 11 wherein said power strip is removably mounted on said moveable cart assembly.
